(19) United States
(12) Patent Application Publication
(10) Pub. No.: US 2007/0002740 A1
(43) Pub. Date: Jan. 4, 2007

(54) Biasing of network node prioritization to improve per-hop behavior based on performance necessary for a packet to meet end-to-end QoS goals

(76) Inventors: Scott Evans, Burnt Hills, NY (US); Amit Kulkarni, Clifton Park, NY (US); John Hershey, Ballston Lake, NY (US); Michael Hartman, Clifton Park, NY (US)

Correspondence Address: DUANE MORRIS LLP, PO BOX 5203, PRINCETON, NJ, 08543-5203, US

(21) Appl. No.: 11/172,005

(22) Filed: Jun. 30, 2005

(51) Int. Cl. H04L 1/00

(52) U.S. Cl. 370/230.1

(57) ABSTRACT

Each local node of a network adjusts the priority of messages passing through the node based on locally available information. If network topology is available, priority can be given to those messages which have the most hops to go. If source identity or time is/are known, the priority of a message can be upgraded for those messages which have already taken a long time or have already experienced a large number of hops. If destination address and network topology are additionally known, end-to-end QoS can tend to be equalized for all paths.

### FIELD OF THE INVENTION

This invention relates to the prioritizing or scheduling of the forwarding of packets arriving at a network node in order to tend to optimize the source-to-destination or the current-node-to-destination transmission or forwarding.

### BACKGROUND OF THE INVENTION

FIG. 1 is a simplified block diagram of a generalized bandwidth-limited network 1 for communicating packets of information among a number of nodes. In FIG. 1, a source node SN (as well as other nodes N) 10 produces packets which are intended or destined for various other nodes. Source node SN is connected by way of a path 11 to a node (N) 12, and node 12 is connected to nodes 14, 16, and 18 by way of paths designated 13, 15, and 17. Node 14 is also connected to node 20 by a path 19. Nodes 16, 18, and 20 are connected to a node 22 by paths 23, 25, and 21, respectively. Node 22 is connected to destination node (DN) 24 by a path 27. Node 24 is connected by a path 29 to a node 26. The packets of information which are transmitted or forwarded over the network may carry data or other information, such as Voice over IP (VOIP).

When a packet of data is produced by source node SN, it will ordinarily carry at least an address tag identifying the destination node. A packet leaving source node 10 traverses path 11. In a basic network, the packet is routed by node 12 by way of one of paths 13, 15, or 17 to nodes 14, 16, or 18, respectively, and each further node moves the packet toward the destination node 14. For example, if the packet arrives at node 20, it may be forwarded to node 22 directly by way of path 21 or by way of node 16. From node 22, the packet traverses path 27 to arrive at destination node 24. Each movement of a packet from one node to the next node is termed a “hop.” Thus, the sequential movement of a packet from source node 10 by way of nodes 12, 16, and 22 to destination node 24 takes four hops. The path from source node 10 to destination node 24 by way of nodes 12, 14, 20, 16, and 22 takes six hops.

The delay which a packet experiences in traversing the system of FIG. 1 depends upon the number of nodes traversed, and upon the delay at each node. It is well understood that some types of packet information can experience substantial delays in transit, but that others, such as Voice over IP (VOIP) can be adversely impacted by excessive delay. In some prior-art systems (such as Differentiated Services (DiffServ)) the packets are tagged with a priority or schedule which indicates the relative importance of expeditious arrival of the packet at its destination node. Another prior-art system is Earliest Deadline First. In the prior art, Earliest Deadline First networks provide rigorous preferential treatment at each node for prioritized classes of traffic. Every packet has an associated time tag called “deadline” where the deadline is the last permissible time of arrival at the ultimate destination node. In effect, Earliest Deadline First forwards or retransmits those packets which have earlier deadlines than those that have later deadline. Thus the packet that has a value of deadline that is the smallest of the values of all packets in the forwarding queue is transmitted first. Similarly, the packet that has a value of deadline that is the largest of the values of all the packets in the queue is transmitted last. The Earliest Deadline First model also has the disadvantage that a packet that has little likelihood of meeting its deadline will in many cases receive the highest priority, causing wasteful use of resources from the perspective of end-to-end (E2E) success.

FIG. 2 illustrates the general structure of a prior-art Proportional Differentiated Services (DiffServ) node which may be used in the network of FIG. 1. DiffServ control has the advantage that the decisions are made locally at each node, and the decisions do not require signaling among the nodes, which consume system resources. In FIG. 2, packets which are tagged with their destination address and with their priority relative to other packets arrive by way of a path 210 at a packet routing block 212, which may perform route selection, source routing, and packet label switching. The packets then go to a class sorting block 214, where they are sorted according to their priority or class. From block 214, the packets are routed to a set 218 of Random Early Dropping (RED) functions designated 218₁, 218₂, 218₃, 218₄, and 218₅, respectively, and then to a set 220 of queues, designated 220₁, 220₂, 220₃, 220₄, and 220₅, respectively. Each RED function randomly drops some packets as its associated queue fills up, to prevent overflow and consequent uncontrolled loss of packets. Each queue contains only packets of a given priority. The queues of set 220 fill up to a greater or lesser degree, depending at least in part upon the number of high priority packets relative to the number of low priority packets. A queue servicing block 222 accesses the queues on a rotating basis. In general, in order to give priority to those queues containing the higher-priority packets, queue servicing block 222 may access (take packets from) a high-priority queue more often than from a low-priority queue. For example, queue servicing block 222 may access low-priority queue 220₅ once for every two times it accesses higher-priority queue 220₄, and may access medium-priority queue 220₃ twice for each time it accesses lower-priority queue 220₄. Similarly, queue servicing block 222 may access highest-priority queue 220₁ twice for every time it accesses lower-priority queue 220₂ and four times for each time it accesses medium-priority queue 220₃. Many other ways are known to service the queues so as to provide priority. Thus, queue servicing block 222 receives packets from the queue set 220 and sends them from the node by way of a path 224. In operation of the arrangement of FIG. 2, lower priority classes of service have lower Quality of Service (QoS), as for example are likely to have longer latency both at the individual node and overall through the system.

Alternative or improved node-controlled network prioritizing is desired.

### SUMMARY OF THE INVENTION

A method according to an aspect of the invention is for controlling the flow of information packets through a node of a network including a plurality of nodes. The method comprises the step of assigning a destination address to each information packet. This assignment may be performed at the time that the packet is initially generated. At each node of the network, the transmission or forwarding of those packets arriving at the node is prioritized according to a predicted cost metric relative to a destination cost goal. The packets may or may not be initially classified according to priority. The prioritization may include promotion or demotion of the packet, or taking no action in relation to priority. Promotion may include tending to advance the time of transmission or forwarding, and demotion may include tending to delay the time of transmission or forwarding. In one mode of the method, the predicted cost metric includes the number of hops to the destination. In another mode of the method, the predicted cost metric includes predicted time to destination relative to a goal destination time to destination. In one advantageous mode of this aspect of the method, transmission time, which may be the initial transmission time, is associated with each packet, and the predicted cost metric relative to a source-to-destination transmission time goal is the sum of predicted time to destination plus time since transmission.

A method according to another aspect of the invention is for controlling the flow of information packets through a node of a network, where the network includes a plurality of nodes along at least one packet path extending through the network. The method comprises the steps of assigning a destination address to each information packet, and, at each node of the network, scheduling the transmission of those packets arriving at the node according to a cost metric including costs expected to be incurred between the node and the destination.

According to another aspect of the invention, a method for controlling the flow of information packets through a node of a network, which network includes a plurality of nodes and where the information packets flow along at least one network path, comprises the steps of assigning a destination address to each information packet, and, at each node of the network, scheduling the transmission of those packets arriving at the node according to a cost metric expressing a cost of travel from the current node to a downstream node. In a particular mode of this method, the scheduling of the transmission advances the probable time of transmission of those packets having a cost metric which represents a greater cost of travel from the current node to a downstream node than others of the packets. In another mode of this aspect of the method, the scheduling includes one of (a) promotion and (b) demotion of the probable packet transmission time, and the promotion of the transmission depends, at least in part, on the availability at the node of resources for promotion. In yet another mode, the step of packet schedule promotion or demotion additionally biases the transmission of the packets in response to a cost metric including at least one of elapsed latency, hops, trust, jitter, and link stability or combination thereof. Trust can be calculated by the Poblano trust determination algorithm. All nodes that are on the path from a given source node and a given destination are assigned trust values using the above computation algorithm.

According to another aspect of the invention, a method for controlling the flow of information packets through a node of a network, which network includes a plurality of nodes and where the information packets flow along at least one network path, comprises the step of, at each node of the network, prioritizing the transmission of those packets arriving at the node according to a cost metric including at least the number of hops remaining from the current node to a downstream node. In a particular mode, this aspect of the method comprises the step of assigning a destination address to each information packet, which destination address identifies a destination node. In this particular mode, the downstream node is the destination node. In another mode of this aspect of the method of the invention, the step of prioritizing of packet advances the priority of those packets traversing a greater number of hops relative to those traversing a lesser number of hops. The prioritizing may include promotion or demotion of the packet, and the promotion of the transmission depends, at least in part, on the availability at the node of resources for promotion. In yet another mode, the step of prioritizing additionally biases the transmission of the packets in response to a cost metric including at least one of elapsed latency, hops, trust, jitter, and link stability.

A method for transmitting messages among a plurality of nodes of a communication network, according to an aspect of the invention, wherein each message is associated with information identifying its destination node, comprises the steps of providing each node of the network with a memory programmed with network topology information and, for each message arriving at a node, determining, from the network topology and the destination node, the number of remaining hops cost metric required for the message to arrive at the destination node after leaving the current node. The scheduled order of transmission is advanced for at least some of those messages which require the largest number of remaining hops cost metric. The messages may be packets. The advancing step may comprise the step of placing the messages which require the largest number of remaining hops in a queue which is serviced more often than other queues. In a mode of this method, the advancing step may be performed for those messages exceeding a predetermined number of remaining hops.

A method according to an aspect of the invention, for transmitting messages among a plurality of transceiver nodes through a bandwidth-limited network, comprises the step of, at each transceiver node, associating a priority-indicating code to each message to be transmitted, and monitoring the loading of the network. At each transceiver node, the priority of each arriving message is monitored or noted, the servicing of packets at each transceiver node is biased by at least one end-to-end Quality of Service goal and the current priority or status of packets relative to the goal. The rate of the servicing of packets may be greater when the priority is higher, and lesser when the priority is lower.

A method according to an aspect of the invention is for controlling the flow of information messages through a node of a network, which network includes a plurality of nodes, and where the information messages flow along at least one network path. The method comprises the steps of assigning a source and destination address to each information message, and, at each node of the network, prioritizing the forwarding of those messages arriving at the node according to a cost metric including at least the total number of hops required for the message to travel from the source to the destination.

An other mode according to an aspect of the invention is for controlling the flow of information messages through a node of a network, which network includes a plurality of nodes, and where the information messages flow along at least one network path. The method comprises the steps of assigning a source transmission time and destination address to each information message, and at each node of the network, prioritizing the forwarding of those messages arriving at the node according to a cost metric including at least the total time since the message was sourced and the expected time required for the message to reach the destination. In a particular mode of this method, the cost metric may include at least the sum of (a) the time since the message was sourced and (b) the expected time required for the message to reach the destination.

In this other mode, the method further comprises the step of, at the source of the message, assigning a classification to the message indicating its sensitivity to delay. The cost metric includes at least the sum of (a) the time since the message was sourced and (b) the expected time required for the message to reach the destination, compared with a goal overall transmission time.

### BRIEF DESCRIPTION OF THE DRAWING

FIG. 1 is a simplified block diagram of a general network including interconnected nodes;

FIG. 2 is a simplified block diagram illustrating a prior-art node arrangement which may be used in the network of FIG. 1;

FIG. 3 is a simplified block diagram similar to FIG. 2, including a triage biasing block according to an aspect of the invention;

FIG. 4 is a simplified logic flow chart or diagram illustrating one type of logic operation which may be performed by the triage biasing block of FIG. 3, showing how the logic adjusts priority of service of the current hop based on the remaining number of hops to the destination;

FIG. 5 is a simplified logic flow chart or diagram illustrating another type of logic operation which may be performed in the triage biasing block of FIG. 3 showing how the logic adjusts priority both up and down;

FIG. 6 illustrates a simplified process chart for determining the level of distress or conversely the amount of slack available for a packet to be demoted in service priority; and

FIGS. 7a and 7b describe how local information regarding packet service rates can be combined with design service rate delays to determine the ability of a packet to meet average per-class E2E latency constraints within prescribed safety factors.

### DESCRIPTION OF THE INVENTION

The invention relates to Adaptive Quality of Service (QoS) for communications networks and attempts to achieve end-to-end QoS using triage-based per-hop behaviors. In this context, the term “triage” refers to evaluation of the packets to determine which ones are beyond saving (as by being so late as to no longer be useful), which require immediate attention (are late, but still useful), or are in good condition or at least relatively good condition (not late or even early). The approach is different from “Best Effort” per-hop behaviors that maximize network throughput but that do not differentiate QoS among classes of traffic, and is also different from Proportional Differentiated Services that provide rigorous preferential treatment for prioritized classes of traffic. The approach of the invention seeks to provide “Enough Effort” at each hop in a prioritized way or scheduled manner that maximizes end-to-end (E2E) success of flows in the network. While applicable to all IP based networks, the invention is particularly relevant for mobile wireless ad-hoc networks where dynamic topology and varied bandwidth among links make QoS a difficult challenge. A high priority and difficult challenge for these networks is the simultaneous coexistence of real time traffic such as Voice Over IP (VOIP) and data traffic.

The approach generally attempts to maximize network-source-to-network-destination “goodput” of packets, or at least local-node-to-network-destination goodput, relying on processing performed at the local node. “Goodput” differs from network throughput in that packets contributing to successful “goodput” arrive at a node in time or within other QoS criteria such that they contribute to the end-to-end mission success. Thus, goodput does not take into account packets which arrive at the destination too late to contribute to the information. Reliance on the local node prevents (or at least minimizes) the utilization of network bandwidth resources for throughput control. The actions which can be taken at a local node depend upon the information available to the local node. The packet label information (ordinarily included in a packet header at the packet source) may provide some of this information. For example, the packet will always carry at least the network destination address. This by itself may not be too helpful in throughput control, but if coupled with a local memory at each node which maps the network (and the location of the local node within the network), simple control can be performed. In such a simple control, the network map is used to determine the number of remaining hops which a packet must undergo on its journey to the destination. A simple form of throughput control in such a situation is to advance in the local queue (promoted) those packets which require the largest number of hops to reach the destination. Such a control tends to equalize the network delay from the local node to the destination. In this context, the loading of a local node memory though the network would occur only infrequently if the network topology is largely static, and thus might not be an appreciable load on the network bandwidth. Even this slight loading could be eliminated for a static network if the local node can be loaded locally by the operator.

If more information is available to the local node, more complex throughput control can be achieved. For example, if, in the “local memory with network topology” example the packet header provides the network address of the packet source in addition to the destination address, this additional information can be used to estimate the total delay in hops (or in time, if the memory is so programmed) which a packet will experience during its entire journey through the network. Given such information,

A packet header may include a time marker indicating when it was originally transmitted from the source node. This information can also be used to aid in controlling throughput, in much the same way as the number of hops. In addition, if the “sending time” tag is available and the local memory is preprogrammed with a “goal” time delay, those packets which are relatively late may be advanced in the queue. Yet further, if the sending time and the class or priority of the packet is identified, and if the memory of the local node is preprogrammed with a “goal” maximum delay for each class of packet, those packets of a given class which are falling behind can be advanced by promoting to a queue that is served more frequently. This might have application to those situations in which voice (VOIP) packets or messages are transmitted intermixed with data packets. Those skilled in the art know that the voice packets, if excessively delayed are deemed not to be useful and are thrown away or discarded.

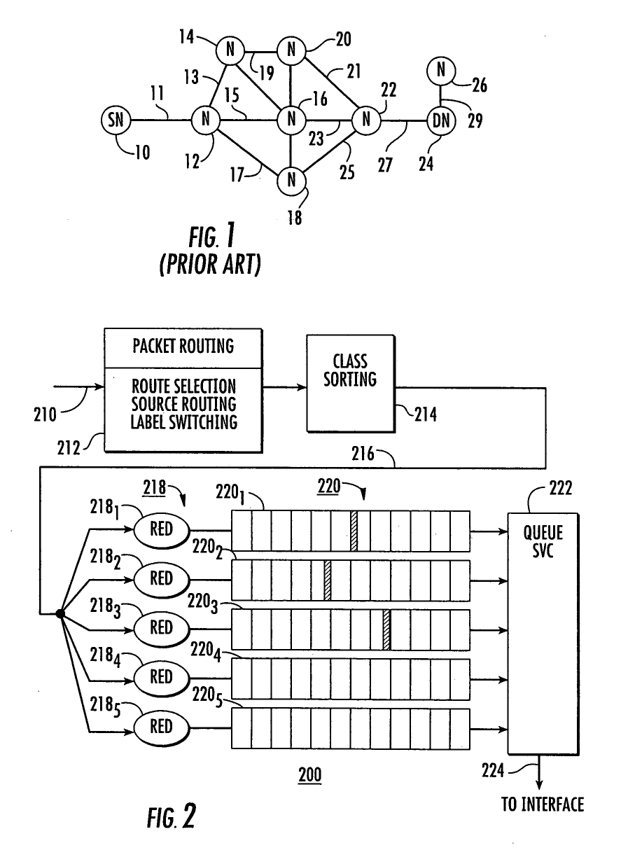

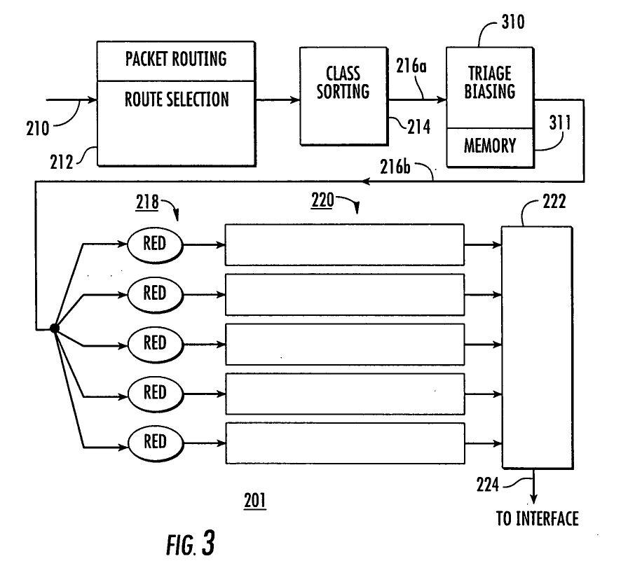

FIG. 3 is a simplified block diagram of a node according to an aspect of the invention, which may be used in the system of FIG. 1. FIG. 3 is similar to FIG. 2, and corresponding elements are designated by like reference numerals. The arrangement of FIG. 3 differs from the arrangement of FIG. 2 by including a triage biasing block 310 interposed between class sorting block 214 and the set 218 of Random Early Dropping functions. The node of FIG. 3 includes a memory, as for example the memory 311. In FIG. 3, the sorted packets from class sorting block 214 are applied by way of a path portion 216a to triage biasing block 310, and the triage biased packets flow to the set of Random Early Dropping functions by way of a second path portion 16b.

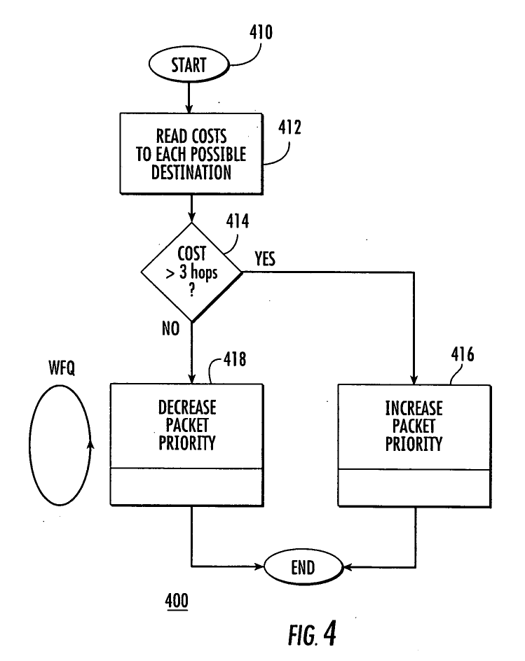

FIG. 4 is a simplified logic flow chart or diagram illustrating one possible form of triage biasing which may be performed in block 310 of FIG. 3 according to an aspect of the invention. In FIG. 4, the logic begins at a START block 410, and flows to a further block 412, which represents the reading of a local memory which lists all possible destinations and the number of hops associated with the traversal of the system from the current node to the destination, and the assigning to each packet of an estimated or projected cost in the form of the number of additional hops. While the number of hops which the packet will experience after leaving a node may vary depending upon the route which it takes through the network, the node has available a route table which specifies the routing protocol, so the node “knows” the packet's path to be taken through the network. From block 412, the logic of FIG. 4 flows to a decision block 414, which compares the cost to some reference cost, or more particularly in this embodiment compares the number of projected hops for the packet to some reference cost or number, such as three hops. Decision block routes the logic by way of its YES output if the cost is greater than three hops, to a block 416, and by way of its NO output to a block 418 if the cost is less than three hops. Block 416 represents the changing of the priority of the packet, and more particularly the increasing of the priority of the packet. Block 418 represents decreasing the priority of the packet (demotion), but could also represent leaving the current priority intact. From either block 416 or 418, the logic reaches an END block 420. The logic of FIG. 4 is performed for each packet traversing a node. In the overall system of FIG. 3, the packets leaving the class sorting block 214 have their priorities adjusted by triage biasing block 310. The triage-biased packets then proceed to the five queues of set 220 and enter the queue appropriate to their current priority. Those packets which were advanced in priority by the triage biasing block land in queues which are accessed more often, or are otherwise serviced more promptly. Those packets which are not advanced, of course, end up in the same queue as that which their current priority warrants. It will be clear that instead of a single decision block 414, a cascade of decision blocks could be used, each responding to a different number of hops, to more finely segregate the packets, so that multiple levels of advancement could be used for those packets having the greatest projected number of hops.

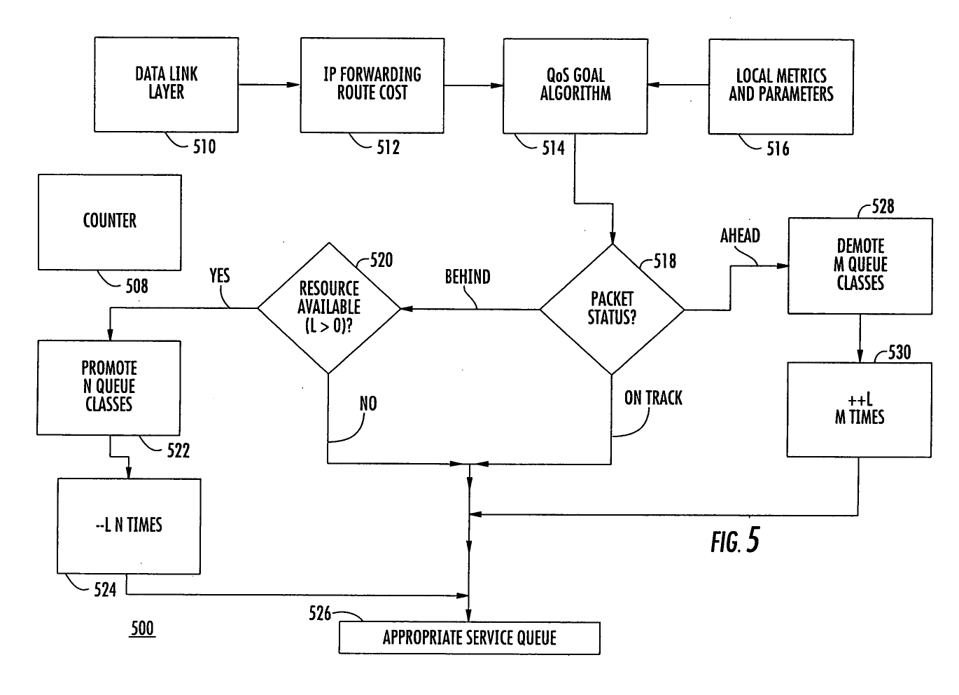

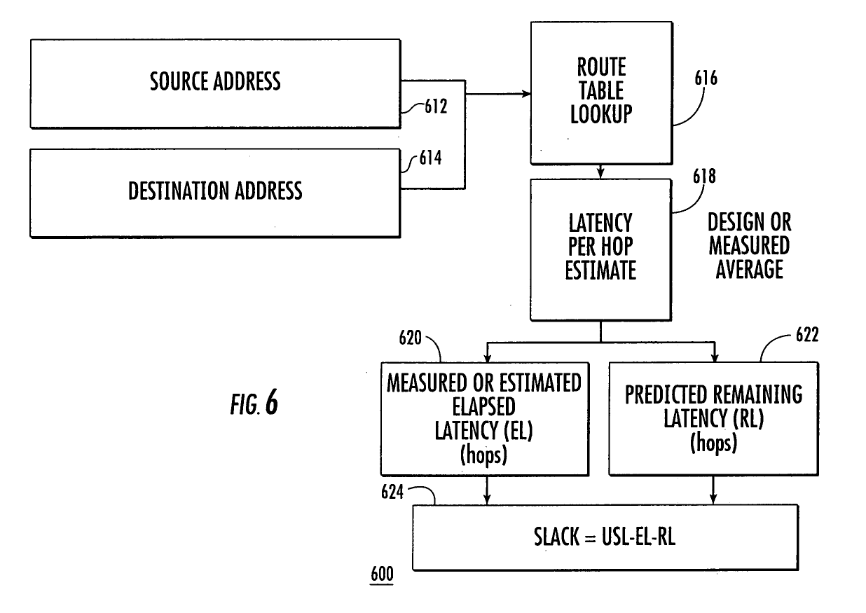

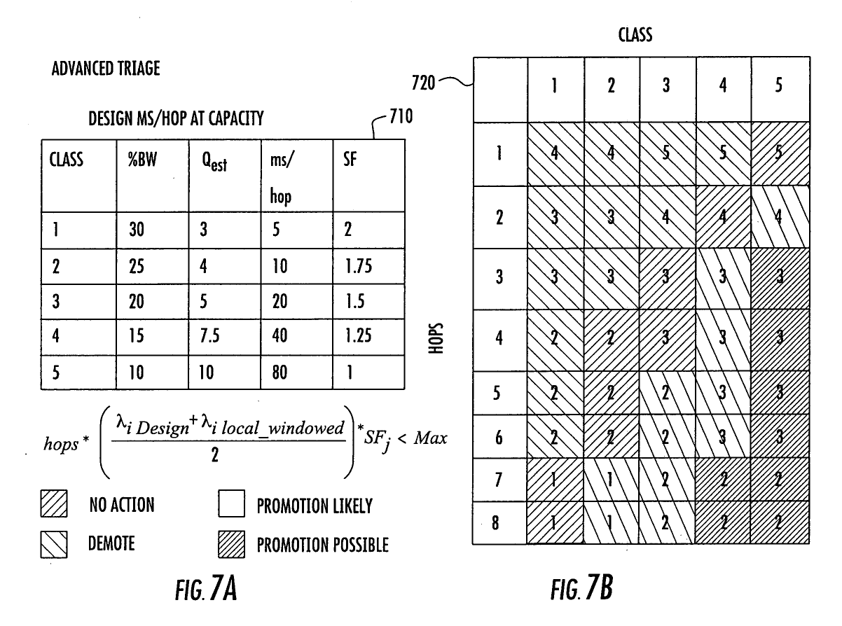

FIG. 5 is a simplified flow chart or diagram illustrating control of promotion under triage such that promotions only occur if the net promotion/demotion effect of the triage is neutral. In FIG. 5, the information arrives at a data link layer represented by a block 510, and proceeds to a block 512, which represents the accessing of information relating to the route cost involved in forwarding the current packet to its destination. This may be measured in the number of future hops, as described in conjunction with FIG. 4. From block 512, the logic of FIG. 5 proceeds to a Quality-of-Service (QoS) block or algorithm 514, which receives local metrics and parameters such as route cost, average per-class latency, jitter, link stability, trust or security metric, or any locally available metric. Trust can be calculated as a metric using the Poblano trust computation algorithm, described in A Distributed Trust Model for Peer-to-peer Networks, Rita Chen and William Yeager, Sun Microsystems, 2001. Mixed routing metrics are well known in the state of the art, and any mixed routing metric that provides a measure of end-to-end goodness to be optimized can be used to drive the Triage algorithm. QoS block 514 determines status of a packet with respect to QoS goals, as described in conjunction with FIG. 6. For example, FIG. 6 shows the determination of the QoS status with respect to E2E latency through the use of locally available route cost metrics. The logic then flows to a decision block 518, which determines if the packet is ahead of or behind schedule. If the packet is behind schedule, the logic flows from the “behind” output of decision block 518, and arrives at a further decision block 520. Decision block 520 examines the state of a promotion/demotion counter illustrated as a block 508. If counter 508 shows that resources are available, that is, that the count of counter 508 is greater than zero, the logic leaves decision block 520 by the YES output, and proceeds to a block 522, which represents the promotion of the packet by at least one queue class, or if M classes are available by up to M queue classes. In general, this is accomplished by promoting or demoting a packet to the lowest service class that can meet the QoS goal within a safety factor for the packet's native class, as described below in conjunction with FIG. 7. From block 522, the logic proceeds to a block 524, which represents decrementing of the count of counter 508 by M, to thereby indicate a lesser ability to effect promotions. From block 524, the logic sends the packet to the appropriate service queue, as suggested by block 526. If decision block 520 should determine that the value of counter 508 is less than or equal to zero, and thereby indicative of lack of promotion resources, the logic leaves decision block 520 by the NO output, and proceeds directly to block 526 without effecting the promotion.

In the logic of FIG. 5, the packet may be ahead of schedule instead of behind schedule. If the packet is ahead of schedule, such that demotion will not adversely affect its QoS, decision block 518 examines its status and routes the logic by way of an AHEAD output to a block 528. Block 528 demotes the packet by M queue classes, and the logic flows to a block 530. Block 530 represents the incrementing of counter 508 by M, to thereby indicate the availability to promote by M queue classes. From block 530, the logic proceeds to block 526, representing the sending of the demoted packet to the appropriate service queue. For completeness, the logic leaves decision block 518 by the ON TRACK output for those packets which are neither ahead of schedule nor behind.

FIG. 6 is a simplified process chart 600 for determining the level of distress or conversely the amount of slack available for a packet to be demoted in service priority. In FIG. 6, the Quality of Service (QoS) is determined with respect to end-to-end (E2E) latency through the use of locally available route cost metrics. More particularly, when a packet arrives at a local node, the node examines the source address 612 and the destination address 614 associated with the packet, and the logic proceeds to a block 616, which represents the entry into a route table look-up or memory, which projects the route the packet has taken, and will take from the local node to the destination node. This gives a value representing the anticipated total number of transit hops. The logic of FIG. 6 proceeds to a block 618, which represents an application of the latency per hop to the route table information. The latency per hop may include historical data relating to those nodes already traversed, or it may be a simple predetermined average value. The latency per hop for future hops can be only an estimate. The results of these calculations result in measured or estimated elapsed latency (EL) in hops, or possibly in actual time, as suggested by block 620, and predicted remaining latency (RL) in hops or in time, as suggested by block 622. From blocks 620 and 622, the logic flows to a block 624, representing the determination of the slack as being the Upper Spec Limit (USL), from which both Elapsed Latency (EL) and Remaining (Predicted) Latency (RL) are subtracted. Element 612 specifies the source address of the packet. Element 614 specifies the destination address. Element 616 is the route table lookup. Element 618 specifies the estimate of latency per hop. This may be known in a variety of ways. For example, it may be specified as an invariant number. It may be computed from historical information. It may be a combination of specified (design values) with local historical values. Element 620 estimates elapsed latency (EL) in hops or time. Element 622 predicts remaining latency (RL) in hops or time. Element 624 computes the slack according to the equation: Slack=USL−EL−RL. The Slack is used to determine promotion or demotion of packet service schedule. If Slack is positive, a packet may be a candidate for demotion, whereas if slack is negative a packet is a candidate for promotion.

FIGS. 7a and 7b illustrate one possible method for combining local information regarding packet service rates or delays with design service rate delays to determine the ability of a packet to meet average per-class E2E latency constraints within prescribed safety factors. In this case an average of locally determined class delay is averaged with an a priori defined design delay value. This estimated per-hop delay projected across remaining hops and, in company with elapsed latency and the safety factor, determines whether a packet is promoted or demoted. A packet is demoted or promoted to the highest or lowest class which will meet E2E success criteria within the class safety factor SF, which is a multiplier of estimated latency designed to provide a margin of protection factor for a given class of traffic according to:

$$hops * ( \frac{{λ}_{i Design} + {λ}_{i local\_windowed}}{2} ) * {SF}_{j} < USL$$

In FIG. 7a, table or element 710 represents an example of metrics associated with 5 classes of traffic. For example, class 1 shows 30% of bandwidth reserved (% BW), which implies an estimated queue depth (Qₑₛₜ) of 3 packets and estimated queuing delay of 5 msec per hop (ms/hop). A safety factor of 2 is assigned to class 1. The assumption is made that the design time per hop at full bandwidth capacity for five distinct classes of service is 5 milliseconds per hop (ms/hop) for class 1, 10 ms/hop for class 2, and 20, 40, and 60 ms/hop for classes 3, 4, and 5, respectively, reflecting the different rates at which the various queues are serviced. During the time that any queue is serviced, the packet(s) being forwarded or transmitted are transmitted at the maximum possible bit rate available at that node of the network. One possible queuing algorithm might be weighted fair queuing (WFQ). Class 1 service consumes 30% of the available bandwidth, class 2 service consumes 25%, and classes 3, 4, and 5 consume 20%, 15%, and 10%, respectively. Qest is the estimated queue depth, which may be a windowed average. Qest divided by the service rate equals the queuing delay: Qest_packets/Class_Service_rate_packets_per_second=seconds_of_delay. In this example, under weighted fair queuing strategies well known in the art, up to 30% of available bandwidth (for example 30 packets out of a 100 packets per second service rate) will be taken from the class 1 queue before moving to the class 2 queue. If a smaller amount of traffic is offered than reserved the next class is immediately serviced in accordance with WFQ strategy. Other queuing disciplines can be used with similar embodiments. The safety factor (SF) applied to class 1 is 2 in one embodiment, the safety factor for class 2 is 1.75, and the safety factors for classes 3, 4, and 5 are 1.5, 1.25, and 1.0, respectively; other safety factors may be used. Element or table 720 of FIG. 7b describes the class to which a packet from a given class and number of hops can be promoted within the Safety factor and delay guidelines described in table 710.

As mentioned, the local node can advance those packets which may have only a small number of hops to go, if they have already experienced a large number of hops in arriving at the local node. This is described in FIG. 8, where the remaining latency budget can be determined. This remaining budget can be used to determine the level of slack or distress associated with a packet.

Triage per-hop behaviors for other applications such as real time video, command and control, and other real time applications are envisioned. Local decisioning can be very simple, using latency metrics and thresholding, or more complex, mixed metric decisioning that considers link up time, trust or other metrics.

A method according to an aspect of the invention is for controlling the flow of information packets through a node (N) of a network (1) including a plurality of nodes (10, 16, 26). The method comprises the step of assigning a destination address to each information packet. This assignment may be performed at the time that the packet is initially generated. At each node (N) of the network (1), the transmission or forwarding of those packets arriving at the node (N) is prioritized (promoted, demoted, or not acted upon) according to a predicted cost metric relative to a destination cost goal (such as 3 hops in decision block 414 or USL in block 624). The packets may or may not be initially classified according to priority. The prioritization may include promotion or demotion of the packet, or taking no action in relation to priority, which inaction may be viewed as being a form of demotion when other packets are promoted. Promotion may include tending to advance the time of transmission or forwarding (by assigning or routing the packet to a queue (220₁, for example which receives preferential service), and demotion may include tending to delay the time of transmission or forwarding (by assigning or routing the packet to a queue which receives less preferential servicing). In one mode (400) of the method, the predicted cost metric includes the number of hops to the destination from the current node. In another mode (600) of the method, the predicted cost metric includes predicted time to destination (616, 618) relative to a goal destination-time-to-destination. In one advantageous mode of this aspect of the method, transmission time, which may be the initial transmission time, is associated with each packet, and the predicted cost metric relative to a source-to-destination transmission time goal is the sum of predicted time to destination plus time since initial transmission.

A method according to another aspect of the invention is for controlling the flow of information packets through a node (N) of a network (1), where the network (1) includes a plurality of nodes along at least one packet path extending through the network (1). The method comprises the steps of assigning a destination address to each information packet, and, at each node (N) of the network (1), prioritizing (400, 500, 600) the transmission of those packets arriving at the node (N) according to a cost metric including costs expected to be incurred between the node (N) and the destination.

According to another aspect of the invention, a method for controlling the flow of information packets through a node (N) of a network (1), which network (1) includes a plurality of nodes and where the information packets flow along at least one network (1) path, comprises the steps of assigning a destination address to each information packet, and, at each node (N) of the network (1), scheduling the transmission of those packets arriving at the node (N) according to a cost metric expressing a cost of travel from the current node (N) to a downstream node (N). In a particular mode of this method, the scheduling the transmission advances the probable or expected time of transmission of those packets having a cost metric which represents a greater cost of travel (400) from the current node (N) to a downstream node (N) than others of the packets. In another mode of this aspect of the method, the scheduling includes one of (a) promotion and (b) demotion of the probable packet transmission time, and the promotion of the transmission depends, at least in part, on the availability at the node (N) of resources for promotion (500). In yet another mode, the step of packet schedule promotion or demotion additionally biases the transmission of the packets in response to a cost metric including at least one of elapsed latency, hops, trust, jitter, and link stability or combination thereof.

According to another aspect of the invention, a method for controlling the flow of information packets through a node (N) of a network (1), which network (1) includes a plurality of nodes and where the information packets flow along at least one network (1) path, comprises the step of, at each node (N) of the network (1), prioritizing the transmission of those packets arriving at the node (N) according to a cost metric including at least the number of hops (400) remaining from the current node (N) to a downstream node (N). In a particular mode, this aspect of the method comprises the step of assigning a destination address to each information packet, which destination address identifies a destination node (N). In this particular mode, the downstream node (N) is the destination node (N). In another mode of this aspect of the method of the invention, the step of prioritizing of packet advances the priority of those packets traversing a greater number of hops (400) relative to those traversing a lesser number of hops. The prioritizing may include promotion or demotion (500) of the packet, and the promotion of the transmission depends, at least in part, on the availability at the node (N) of resources for promotion. In yet another mode, the step of prioritizing additionally biases the transmission of the packets in response to a cost metric including at least one of elapsed latency, hops, trust, jitter, and link stability.

A method for transmitting messages among a plurality of nodes of a communication network (1), according to an aspect of the invention, wherein each message is associated with information identifying its destination node (N), comprises the steps of providing each node (N) of the network (1) with a memory programmed with network (1) topology information and, for each message arriving at a node (N), determining, from the network (1) topology and the destination node (N), the number of remaining hops cost metric required for the message to arrive at the destination node (N) after leaving the current node (N). The scheduled order of transmission is advanced for at least some of those messages which require the largest number of remaining hops cost metric. The messages may be packets. The advancing step may comprise the step of placing the messages which require the largest number of remaining hops in a queue which is serviced more often than other queues. In a mode of this method, the advancing step may be performed for those messages exceeding a predetermined number of remaining hops.

A method according to an aspect of the invention, for transmitting messages among a plurality of transceiver nodes through a bandwidth-limited network (1), comprises the steps of, at each transceiver node (N), associating a priority-indicating code to each message to be transmitted, and monitoring the loading of the network (1). At each transceiver node (N), the priority of each arriving message is monitored or noted, the servicing of packets at each transceiver node (N) is biased by at least one end-to-end Quality of Service goal and the current priority or status of packets relative to the goal. The rate of the servicing of packets may be greater when the priority is higher, and lesser when the priority is lower.

A method according to an aspect of the invention is for controlling the flow of information messages through a node (N) of a network (1), which network (1) includes a plurality of nodes, and where the information messages flow along at least one network (1) path. The method comprises the steps of assigning a source and destination address to each information message, and, at each node (N) of the network (1), prioritizing the forwarding of those messages arriving at the node (N) according to a cost metric including at least the total number of hops required for the message to travel from the source to the destination.

Another method according to an aspect of the invention is for controlling the flow of information messages through a node (N) of a network (1), which network (1) includes a plurality of nodes, and where the information messages flow along at least one network (1) path. The method comprises the steps of assigning a source transmission time and destination address to each information message, and at each node (N) of the network (1), prioritizing the forwarding of those messages arriving at the node (N) according to a cost metric including at least the total time since the message was sourced and the expected time required for the message to reach the destination. In a particular mode of this method, the cost metric may include at least the sum of (a) the time since the message was sourced and (b) the expected time required for the message to reach the destination.

In this particular mode, the method further comprises the step of, at the source of the message, assigning a classification to the message indicating its sensitivity to delay. The cost metric includes at least the sum of (a) the time since the message was sourced and (b) the expected time required for the message to reach the destination, compared with a goal overall transmission time.

What is claimed is:

1. A method for controlling the flow of information packets through a node of a network including a plurality of nodes, where said information packets are not classified according to priority, said method comprising the steps of:
assigning a destination address to each information packet;
at each node of said network, prioritizing the transmission of those packets arriving at said node according to a predicted cost metric relative to a destination cost goal.

2. A method according to claim 1, wherein said predicted cost metric includes the number of hops to said destination.

3. A method according to claim 1, wherein said predicted cost metric includes predicted time to destination relative to a goal destination time to destination.

4. A method according to claim 1, further comprising the step of associating transmission time with each packet; and wherein
said predicted cost metric relative to a source-to-destination transmission time goal is the sum of predicted time to destination plus time since transmission.

5. A method for controlling the flow of information packets through a node of a network including a plurality of nodes, where: said information packets flow along at least one network path, said method comprising the step of:
at each node of said network, scheduling the transmission of those packets arriving at said node according to a cost metric expressing a cost of travel from the current node to a downstream node.

6. A method according to claim 5, wherein said scheduling the transmission advances the probable time of transmission of those packets having a cost metric which represents a greater cost of travel from the current node to a downstream node than others of said packets.

7. A method according to claim 5, wherein said scheduling includes one of (a) promotion and (b) demotion of the probable packet transmission time, and the promotion of the transmission depends, at least in part, on the availability at the node of resources for promotion.

8. A method according to claim 7, wherein said step of packet schedule promotion and demotion additionally biases the transmission of said packets in response to a cost metric including at least one of elapsed latency, hops, trust, jitter, and link stability or combination thereof.

9. A method for controlling the flow of information packets through a node of a network including a plurality of nodes, where said information packets flow along at least one network path, said method comprising the step of:
at each node of said network, prioritizing the transmission of those packets arriving at said node according to a cost metric including at least the number of hops remaining from the current node to a downstream node.

10. A method according to claim 9, further comprising the step of assigning a destination address to each information packet, which destination address identifies a destination node; and wherein
said downstream node is said destination node.

11. A method according to claim 9, wherein said step of prioritizing of packet advances the priority of those packets traversing a greater number of hops relative to those traversing a lesser number of hops.

12. A method according to claim 9, wherein said prioritizing includes promotion or demotion of the packet, and the promotion of the transmission depends, at least in part, on the availability at the node of resources for promotion.

13. A method according to claim 9, wherein said step of prioritizing additionally biases the transmission of said packets in response to a cost metric including at least one of elapsed latency, hops, trust, jitter, and link stability.

14. A method for transmitting messages among a plurality of nodes of a communication network, wherein each message is associated with information identifying its destination node, said method comprising the steps of:
providing each node of said network with a memory programmed with network topology information;
for each message arriving at a node, determining, from said network topology and said destination node, the number of remaining hops cost metric required for said message to arrive at said destination node after leaving the current node; and
advancing the scheduled order of transmission for at least some of those messages which require the largest number of remaining hops cost metric.

15. A method according to claim 14, wherein said messages are packets.

16. A method according to claim 14 wherein said advancing step comprises the step of placing said messages which require the largest number of remaining hops in a queue which is serviced more often than other queues.

17. A method according to claim 14, wherein said advancing step is performed for those messages exceeding a predetermined number of remaining hops.
